(19) United States
(12) Patent Application Publication
(10) Pub. No.: US 2003/0186711 A1
(43) Pub. Date: Oct. 2, 2003

(54) Wireless local loop equipment parameter setting system and method

(75) Inventors: Chen-Tao Hsu, Taoyuan Hsien (TW); Cheng-Chung Kao, Ksohsiung (TW)

Correspondence Address: J C PATENTS, INC., 4 VENTURE, SUITE 250, IRVINE, CA, 92618, US

(73) Assignee: SYNCOMM TECHNOLOGY CORP, TAOYUAN (TW)

(21) Appl. No.: 10/065,381

(22) Filed: Oct. 10, 2002

(30) Foreign Application Priority Data
Mar. 28, 2002 (TW) 91106122

(51) Int. Cl. H04Q 7/20

(52) U.S. Cl. 455/462; 455/566; 455/418

(57) ABSTRACT

A wireless local loop equipment parameter setting system and method that uses a telephone attached to wireless local loop equipment to issue a control instruction. The wireless local loop equipment receives the control instruction, translates the instruction and sets or displays the parameters accordingly. A miniature display device connected to the wireless local loop equipment through a serial transmission interface is used to display the control instruction and content of the parameters so that a user may set parameters with ease.

### CROSS REFERENCE TO RELATED APPLICATIONS

This application claims the priority benefit of Taiwan application serial no. 91106122, filed Mar. 28, 2002.

### BACKGROUND OF INVENTION

1. Field of Invention

The present invention relates to a wireless local loop. More particularly, the present invention relates to a wireless local loop equipment parameter setting system and method.

2. Description of Related Art

As society rapidly develops, personal communication through a communication system is increasingly relied on. Due to convenience and ease of installation, wireless equipment is the fastest growing section in the communication industry. Personal access communications system (PACS) is expanding particularly fast because of its low power consumption/low production cost characteristics.

FIG. 1 is a connectivity diagram of subscriber unit equipment in a personal access communications system. Although PACS mainly involves the mobile communication between a cellular phone and a base station, wires are rarely laid in remote and mountainous areas due to inaccessibility. Under such circumstances, the PACS may rely on a fixed subscriber unit 120 linking with a telephone 110 to communicate with a base station 130. To facilitate the establishment of a communication system, parameters utilized by the fixed subscriber unit 120 for communication with users such as the telephone numbers and the scanning range must be appropriately set.

FIG. 2 is a diagram showing a subscriber unit equipment parameter setting system for a conventional PACS. As shown in FIG. 2, parameter setting at the fixed subscriber unit 220 is carried out using a computer 210 through a RS232 interface. The computer 210 can be a desktop computer or a notebook computer as long as the computer has installed a public software setting program that matches the protocol used by the fixed subscriber unit 220. However, this method of access is not quite transportable. For example, the desktop computer, which is suitable for having a fixed linkage with the fixed subscriber unit 220, is not portable. While a fixed linkage satisfies the need for parameter setting, the fixed linkage is really a waste of resources when parameter setting is not required. Although a notebook computer is portable, it is still considered too bulky, impact prone and power strained to move through remote or mountainous regions.

### SUMMARY OF INVENTION

Accordingly, one object of the present invention is to provide a wireless local loop equipment parameter setting system and method capable of using a small auxiliary display device attached to a pre-existent telephone system to set the required parameters. This accessing method is not only portable and user friendly, but also saves the purchasing cost of a computer system.

To achieve these and other advantages and in accordance with the purpose of the invention, as embodied and broadly described herein, the invention provides a wireless local loop equipment parameter setting system. The system includes a telephone, wireless local loop equipment and a display device. The telephone system includes a key-pad through which necessary control instructions concerning the setting or display parameters are sent. The wireless local loop equipment is connected to the telephone through the twisted pair for receiving the control instructions from the telephone, interpreting the message and setting the required parameters. The display device is linked to the wireless local loop equipment through a communication interface so that control instructions and parameter contents are displayed.

In the embodiment of this invention, the wireless local loop equipment is the fixed subscriber unit in a personal access communications system (PACS) and the telephone is a push-button telephone. A combination of keys is used to send out control instructions. The communication interface between the fixed subscriber unit and the display device is a RS232 serial transmission interface and the two communicate with each other using frame control method. The display device further comprises a central processing unit, a serial transmission interface and a display unit.

The parameters that can be set include telephone numbers, radio frequency power, voice volume, radio frequency transmission delay and the scanning range of radio frequency. The displayed parameters may include frequency channel, radio frequency power and transmission error rate.

This invention also provides a wireless local loop equipment parameter setting method that includes the following steps. First, a control instruction related to setting the parameter is issued from the key-pad of a telephone. On receiving the control instruction, the instruction is interpreted, relevant parameters are set and a display message is output. Content of the display message is displayed when the display message is received.

The method utilizes the aforementioned parameter setting system to setting parameters including telephone number, radio frequency power, voice volume, radio frequency transmission delay and the scanning range of radio frequency.

In brief, this invention provides a wireless local loop equipment parameter setting system and method of operation that uses a small display device attached to a preexistent telephone to set all necessary parameters. Hence, non-portable and expensive computer equipment is not required.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a connectivity diagram of subscriber unit equipment in a personal access communications system;

FIG. 2 is a diagram showing a subscriber unit equipment parameter setting system for a conventional PACS;

FIG. 3 is a block diagram showing a wireless local loop equipment parameter setting system according to one preferred embodiment of this invention;

FIG. 4 is a flow chart showing the steps for setting the parameters using wireless local loop equipment according to one preferred embodiment of this invention;

FIG. 5 is a diagram showing the frame format of display device of a wireless local loop equipment parameter setting system according to one preferred embodiment of this invention; and

FIG. 6 is a flow chart showing the steps for displaying the parameters on a display device attached to a wireless local loop equipment parameter setting system according to one preferred embodiment of this invention.

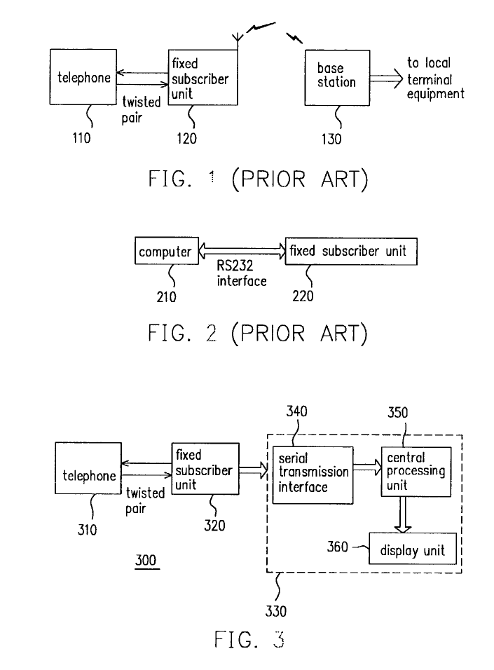

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

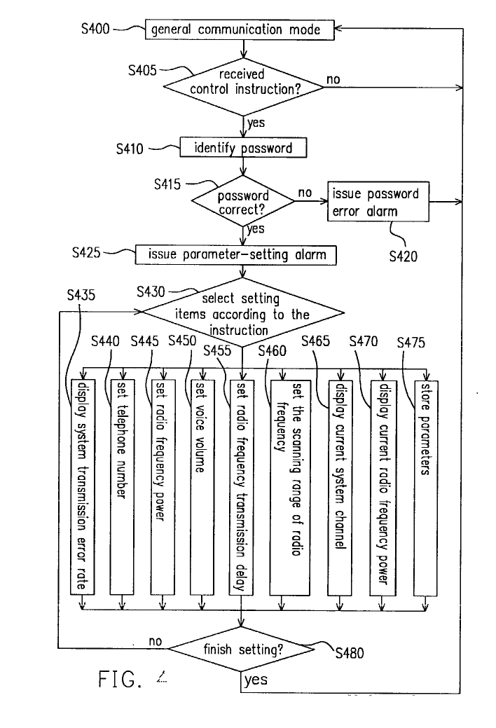

FIG. 3 is a block diagram showing a wireless local loop equipment parameter setting system according to one preferred embodiment of this invention. In FIG. 3, a fixed subscriber unit 320 of a personal access communications system (PACS) is used as an example. However, this by no means limits the scope of this invention. Other wireless local loop equipment is also applicable. As shown in FIG. 3, the wireless local loop equipment parameter setting system 300 includes a telephone 310, a fixed subscriber unit 320 and a display device 330. The display device 330 further includes a serial transmission interface 340, a central processing unit 350 and a display unit 360.

The telephone 310 is a key-in type telephone having a key-pad, for example. A user may issue a control instruction for setting or displaying parameters through keys on the key-pad. Here, the control instruction includes setting system parameter instructions and displaying system state instructions. The setting system parameter instruction is capable of setting user”s parameters such as telephone number and the scanning range of radio frequency, and system parameters such as radio frequency power, voice volume, radio frequency transmission delay. The display system state instruction is capable of displaying current system frequency channel, current radio frequency power, and transmission error rate.

The fixed subscriber unit 320 receives control instruction from the telephone 310 through the twisted pair, interprets the instruction and determines the setting parameters. Thereafter, the fixed subscriber unit 320 outputs a display message that includes contents of the control instruction and the setting parameters. FIG. 4 is a flow chart showing the steps for setting the parameters using wireless local loop equipment according to one preferred embodiment of this invention. As shown in FIG. 4, the fixed subscriber unit 320 is normally in a general communication mode (S400) but constantly polls for the presence of any control instruction (S405). When a control instruction is detected, password identification is carried out (S410). The user-input password is checked for any error (S415). If an error is found in the input password, a password error bell is sounded (S420) to inform a user that the request to access parameter setting and display content has been rejected. On the other hand, if the user-input password is correct, a sound granting the access is issued (S425) so that a user may provide the instruction for setting or displaying the parameters. The setting items are selected according to the instruction (S430). The items include but are not limited to display system transmission error rate (S435), set telephone number (S440), set radio frequency power (S445), set voice volume (S450), set radio frequency transmission delay (S455), set the scanning range of radio frequency (S460), display current system channel (S465), display current radio frequency power (S470) and storage parameters (S475). The user is free to select different setting or display parameter content repeatedly and choose whether to store up the setting parameters or not. After the setting process is complete (S480), the system returns to a general communication mode (S400) for normal communication.

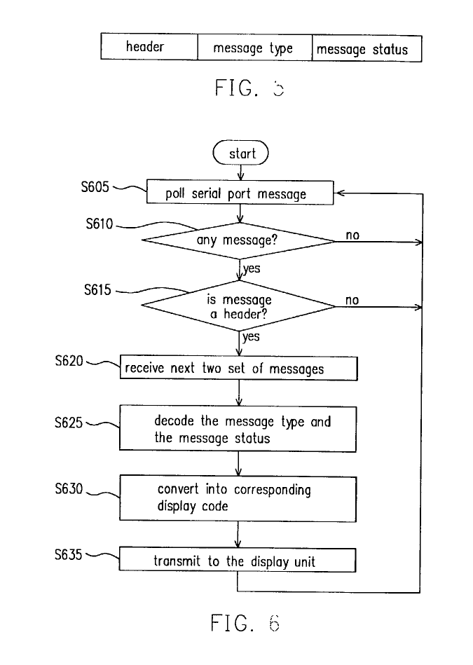

The serial transmission interface 340 of the display device 330 is a RS232 serial transmission interface, for example. The RS232 serial interface provides a transmission interface for receiving a display message from the fixed subscriber unit 320. The central processing unit 350 receives the display message and translates into a corresponding display code so that the display unit 360 may display the message. FIG. 5 is a diagram showing the frame format of display device of a wireless local loop equipment parameter setting system according to one preferred embodiment of this invention. Data is transmitted under frame control method and each frame includes three bytes. Each byte represents one set of message. The first byte is a header, the second byte is a message type and the third byte is a message status. The header byte identifies the start of a message. The header byte is internally set to FFH. The message type includes but is not limited to display system transmission error rate, set telephone number, set radio frequency power, set voice volume, set radio frequency transmission delay, set the scanning range of radio frequency, display current system frequency channel and display radio frequency power. Each item is represented using a different value. The message status is the actual content of the message.

FIG. 6 is a flow chart showing the steps for displaying the parameters on a display device attached to a wireless local loop equipment parameter setting system according to one preferred embodiment of this invention. The steps are carried out by the central processing unit 350 inside the display device 330. In the beginning, a program will check the serial port message (S605) to determine the presence or absence of a message (S610). If a message is found, the message is analyzed to determine if there is a message header (S615). In this example, the message is checked for the code FFH. When the FFH is received, the next two set of messages are also received (S620). The message type and message status are decoded (S625) and then translated into a corresponding display code (S630). Finally, the display code is sent to the display unit 360 (S635) to display the message. Hence, contents of the control instruction and parameters are displayed on demand.

This invention also provides a method of operating the aforementioned wireless local loop equipment parameter setting system and includes the following steps. First, a control instruction for setting parameters is issued from the key-pad of a telephone. On receiving the control instruction, a fixed subscriber unit translates the control instruction and sets the parameters. Finally, a display message is output from the fixed subscriber unit and displays the content of the message in a display device.

The method can be applied to the parameter setting system of a fixed subscriber unit in a PACS so that various parameters including telephone number, radio frequency power, voice volume, radio frequency transmission delay, the scanning range of radio frequency are set by keying in sequence by a telephone. Furthermore, control instruction and content of the parameters are displayed through a miniature display device.

In summary, this invention provides a wireless local loop equipment parameter setting system and method of operation that uses a small display device attached to a key-in type telephone to set and display parameters. Hence, neither non-portable computer equipment nor a power constrained notebook computer need be purchased so that parameter setting and display is very much simplified.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A wireless local loop equipment parameter setting system, comprising: a telephone having a key-pad thereon, wherein a user may issue a control instruction for setting the parameters by the key-pad; wireless local loop equipment coupled to the telephone through telephone cable, wherein the wireless local loop equipment receives the control instruction from the telephone, translates the instruction and sets the parameters and outputs a display message; and a display device connected to the wireless local loop equipment through a communication interface, wherein the display device receives and displays the content of the display message.

2. The system of claim 1, wherein the wireless local loop equipment is the fixed subscriber unit of a personal access communications system (PACS).

3. The system of claim 1, wherein the telephone is a key-in type telephone.

4. The system of claim 3, wherein the control instruction has the capacity to set and display parameters through a series of key combinations.

5. The system of claim 1, wherein the communication interface includes a serial transmission interface.

6. The system of claim 5, wherein the display device and the wireless local loop equipment are adapted to communicate with each other using frame control method.

7. The system of claim 1, wherein the display device further includes: a serial transmission interface for receiving the display message; a central processing unit coupled to the serial transmission interface for receiving the display message, translating the display message and converting the message into a corresponding display code; and a display unit coupled to the central processing unit for displaying the display message according to the display code.

8. The system of claim 1, wherein the parameters includes telephone number, radio frequency power, voice volume, radio frequency transmission delay, the scanning range of radio frequency, current system channel and transmission error rate.

9. The system of claim 1, wherein the display message includes the control instruction and the content of the parameters.

10. A wireless local loop equipment parameter setting method, comprising the steps of: issuing a control instruction for setting parameters through a telephone having a key-pad thereon; receiving the control instruction, translating the instruction, setting the parameters and outputting a display message; and receiving the display message and displaying the content of the display message.

11. The method of claim 10, wherein the wireless local loop equipment is the fixed subscriber unit of a personal access communications system (PACS).

12. The method of claim 10, wherein the telephone is a key-in type telephone.

13. The method of claim 12, wherein the control instruction has the capacity to set and display parameters through a series of key combinations.

14. The method of claim 10 wherein the parameters include telephone number, radio frequency power, voice volume, radio frequency transmission delay, the scanning range of radio frequency, current system channel and transmission error rate.

15. The system of claim 10, wherein the display message includes the control instruction and the content of the parameters.
